(19) United States
(12) Patent Application Publication
(10) Pub. No.: US 2014/0169582 A1
(43) Pub. Date: Jun. 19, 2014

(54) User interface for intelligent headset

(71) Applicant: William O. Brown, Santa Cruz, CA (US)

(72) Inventor: William O. Brown, Santa Cruz, CA (US)

(73) Assignee: Plantronics, Inc.

(21) Appl. No.: 11/479,423

(22) Filed: Jun. 30, 2006

(51) Int. Cl. H04R 1/10

(52) U.S. Cl. CPC H04R 1/1041
USPC 381/74

(57) ABSTRACT

Systems and methods for a mobile communication device are disclosed. A communications headset including a voice prompt unit for outputting an audio prompt through a headset speaker. A user interface is disposed on the headset housing and capable of receiving a user action associated with a next command, previous command, select command, cancel command, and home command.

### BACKGROUND OF THE INVENTION

Recent developments in the telecommunications industries have produced telecommunications devices with increased capabilities. As a result, the complexity of interacting with these devices has increased. Headsets are now capable of doing more than being simple peripherals to legacy phones. For example, the headsets may control navigation through MP3 files. Internet Protocol (IP) based headsets offer the potential of many new applications, all requiring a simple mechanism to access.

However, headset form factors do not lend themselves well to traditional user interface technologies like keypads and displays which are suited for complex user man-machine interface interactions. For example, the available space on the headset housing is limited. In the prior art, headset user interfaces typically consist of a small number of multifunction buttons and a multifunction visual indicator. This limited user interface makes access to more complex features and capabilities difficult and non-intuitive, particularly when the headset is being worn. Visual indicators have limited use while the headset is being worn. Multifunction buttons are non-intuitive and awkward to use.

As a result, there is a need for improved methods and apparatuses for headset user interfaces.

### BRIEF DESCRIPTION OF THE DRAWINGS

The present invention will be readily understood by the following detailed description in conjunction with the accompanying drawings, wherein like reference numerals designate like structural elements.

FIG. 1 illustrates a perspective view of one example of a mobile headset of the invention.

FIG. 2 illustrates a simplified block diagram of the components of a headset in one example of the invention.

FIG. 3 illustrates a simplified block diagram of the components of the headset shown in FIG. 1.

FIG. 4 illustrates a hierarchically ordered menu in which a user may navigate with a headset in one example of the invention.

### DESCRIPTION OF SPECIFIC EMBODIMENTS

Methods and apparatuses for wireless mobile communication devices are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

Generally, this description describes a method and apparatus for a wireless mobile communication device such as a headset with a user interface capable of performing complex interactions. While the present invention is not necessarily limited to headsets, various aspects of the invention may be appreciated through a discussion of various examples using this context.

In one example, a simple general purpose user interface optimized for headsets is provided to allow intuitive control of advanced features and capabilities present and future headsets will have. Features will relate not only directly to the operation of the headset but also potentially the control of adjunct or host devices or server based applications. The user interface is intuitive, flexible and extensible. It is ideally suited for managing complex applications through a headset. As such, it allows the headset to interact with a variety of host devices.

According to an example embodiment of the present invention, a communications headset includes a housing, speaker, microphone, and voice prompt unit for outputting an audio prompt through the speaker. A user interface is disposed on the housing capable of receiving a user action associated with a next command, previous command, select command, cancel command, and home command.

According to an example embodiment of the present invention, a communications headset includes a housing having a boom, a speaker, and a microphone. A touch pad is disposed on the boom capable of performing actions associated with a next command, previous command, select command, cancel command, and home command. Such actions may be performed, in no particular order, by movement along the touch pad in a first direction towards the microphone, movement along the touch pad in a second direction towards the speaker, tapping the touch pad once, tapping the touch pad twice in rapid succession, and tapping the touch pad three times in rapid succession.

According to an example embodiment of the present invention, a method for using a communications headset includes providing a headset with a user interface capable of receiving a user action associated with a next command, previous command, select command, cancel command, and home command. The headset includes a plurality of operational modes. A selected operational mode is received from a user, and an audio prompt is output responsive through a headset speaker responsive to the selected operational mode. A user action is received associated with a next command, previous command, select command, cancel command, or home.

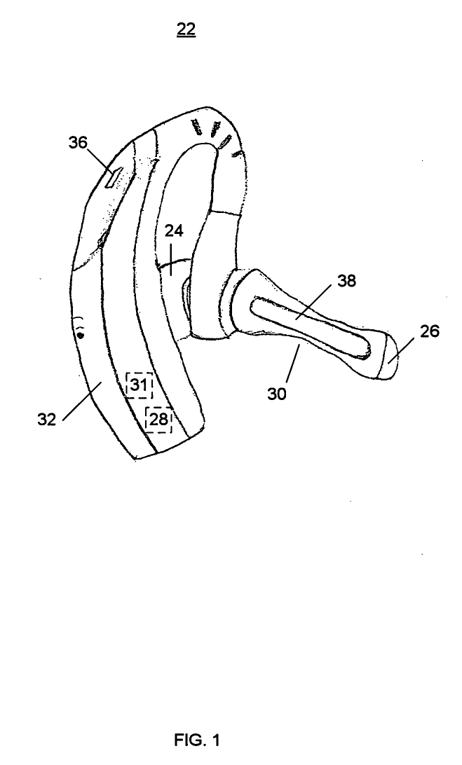

Referring to FIG. 1, a perspective view of a mobile communication device in the form of an over-the-ear headset 22 is illustrated. The headset 22 includes a speaker 24, a microphone 26, a user interface 38, optional status indicator 36, and a wireless communication module 31 installed within a housing of the headset 22. The term “module” is used interchangeably with “circuitry” herein. The headset 22 includes a boom 30 with the microphone 26 installed at the lower end of the boom. The main housing of the headset may be in the shape of a loop 32 to be worn behind a user's ear. The headset 22 further includes a power source such as a rechargeable battery 28 installed within the housing.

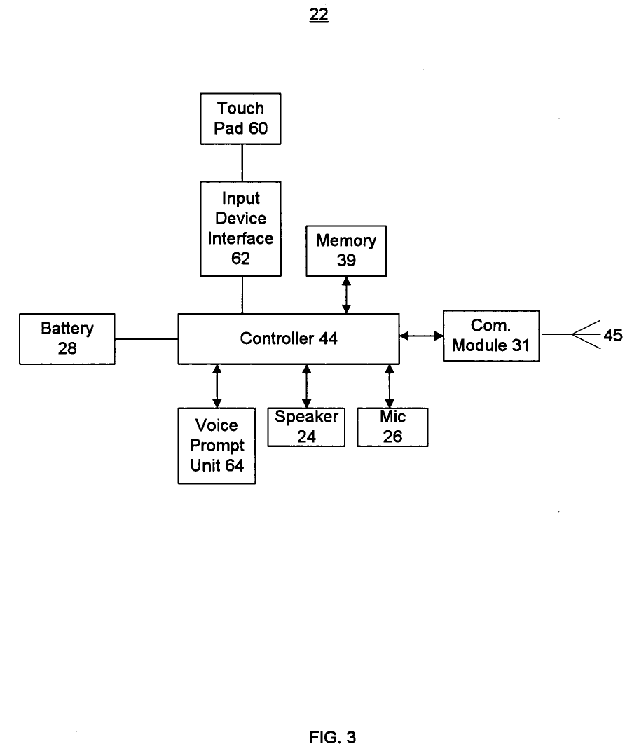

User interface 38 is capable of performing user interface actions typical of that with a headset, such as volume control and on/off functions. In one example of the present invention, user interface 38 allows the user to selectively perform the following actions: Next, Previous, Select, Home, and Cancel. As a result, the user is capable of easily navigating hierarchical menus or capable of use with more complex applications. In one example of the invention, as illustrated in FIG. 1, user interface 38 is implemented using a strip-shaped touch pad. The touch pad is described in further detail below in reference to FIG. 3.

In a further example, user interface 38 is implemented using a rocker switch. For example, rocking in a direction towards the speaker performs a Next action, rocking in a direction towards the microphone performs a Previous action, pushing in once performs a Select action, pushing in twice performs a Cancel action, and pushing in three times performs a Home action. In a further example, embedded voice commands are used to implement the described Next, Previous, Select, and Cancel, and Home functions.

In one example, the user interface 38 provides an action confirmation following user action to indicate to the user that an action has been implemented. In many cases, confirmation of the action taken by the user will simply be a new set of menu choices. For instance, a ‘voice dial’ action would be followed by prompt for name dial or digit dial. However, sometimes a more firm confirmation is desired (e.g. an audio prompt ‘voice dial selected’). The use of a firm confirmation can be a configurable preference. In one example, earcons are used to provide action confirmations. In the context of the present application, the term “earcon” is used to refer to any distinctive auditory user interface element, or any sound that takes on distinguishable meaning in the context of a particular application or operation. Earcons can be thought of as auditory analogues to icons in the visual domain (i.e. distinctive interface elements that represent functions or objects). For example, the earcon confirming a Next action could consist of a tone sweeping up in frequency and the Previous action could be confirmed with an earcon consisting of a tone sweeping down in frequency. The Select action could be confirmed with a single click, a Cancel action could be confirmed with a double click, and a Home action could be confirmed with a triple click.

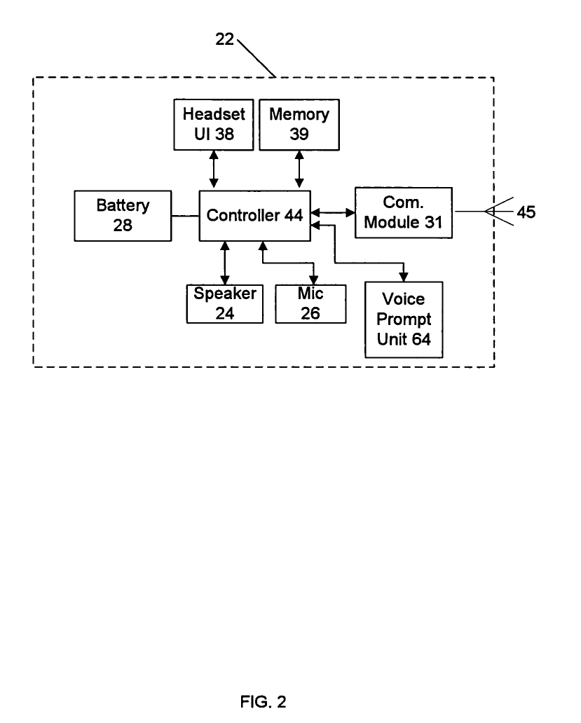

FIG. 2 illustrates a simplified block diagram of the components of a headset in an example of the invention. Headset 22 may include a controller 44 which utilizes a processor, memory 39, and software to implement functionality as described herein. The controller 44 receives input from headset user interface 38 and manages audio data received from microphone 26 and sent to speaker 24. The controller 44 further interacts with wireless communication module 31 to transmit and receive signals to and from the headset 22. Wireless communication module 31 includes an antenna 45. Battery 28 provides power to the various components of the headset. In a further example, the wireless communication module 31 may include a controller which controls one or more operations of the headset 22.

Microphone 26 detects the user's speech, and the analog signals formed are converted by an A/D converter before the speech is encoded by an audio codec unit. Controller 44 forms the interface to the user interface 38 and memory 39, which includes RAM and ROM. An audio codec decodes a speech signal from a far end user and outputs the speech to speaker 24 following conversion by a D/A converter.

The controller 44 is connected to the user interface 38 and monitors the activity in the headset and controls the audio output in response thereto. Controller 44 receives user actions from headset user interface 38 and detects the occurrence of a state change event and changes the state or settings of the headset. A state change event may be caused by the user when he or she initiates an action on the user interface 38 or other type of user input means. Alternatively, a state change event may occur automatically, as in the example of an incoming call.

Wireless communication module 31 may use a variety of wireless communication technologies. In one example, mobile communication device 22 communicates over a personal area network (PAN) via the wireless link established by wireless communication module 31. In one example, wireless communication module employs Bluetooth, 802.11, or DECT standards based communication protocols. In one example, wireless communication module 31 communicates over an RF network employing the Bluetooth standard with corresponding Bluetooth modules at a host device. The Bluetooth specification, version 2.0, is hereby incorporated by reference. A prescribed interface such as Host Control Interface (HCI) is defined between each Bluetooth module. Message packets associated with the HCI are communicated between the Bluetooth modules. Control commands, result information of the control commands, user data information, and other information are also communicated between Bluetooth modules.

Headset 22 includes an audio prompt unit for outputting either an audio voice prompt or an earcon. In one example, the audio prompt unit includes a voice prompt unit 64 coupled to controller 44. Voice prompt unit 64 operates in a manner similar to voice response units. Voice prompt unit 64 responds to user actions at the headset user interface by using a voice prompts program to transmit audio voice prompt messages to the user via the headset speaker 24. The voice prompts program is stored in memory at the headset and executed by controller 44 and contains menu files. A typical voice prompt message instructs the user to perform actions with the user interface or lists selection items. For example, the voice prompt message may inform the user to perform the “Select” action to select an item from a list of items. After receiving the voice prompt message, the user performs a desired action. In one example operation, voice prompt unit 64 includes a voice prompt decoder which receives a digital prompt message from controller 44 and decodes the digital prompt message into a voice prompt message. A speech recognition program executed by controller 44 may optionally recognize the user's voice commands received at the headset microphone in response to the voice prompt messages. In a further example, the voice prompts are received from a remote voice response unit (VRU) with which the user interacts by performing actions at user interface 38.

Referring to FIG. 3, a block diagram of the headset of FIG. 1 in which user interface 38 is a touch pad input device is shown. The touch pad input device enables inputting of coordinate data and performing various functions/actions supported by related touch pad driver code installed in the headset. Controller 44 receives input from touch pad 60 via an input device interface 62. In one example, input device interface 62 includes a microprocessor having ROM storing firmware controlling input of the action data generated in the touch pad 60. The input of the input device interface 62 is connected with the output of touch pad 60. The output of input device interface 62 is coupled to controller 44. In operation, touch pad 60 senses positions of a finger touched at the pad and outputs coordinate data or other action data to the input device interface 62. The coordinate data may be either one or two dimensional. The input device interface 62 converts pointing data received from the touch pad 60 into user action code and supplies it to controller 44. Input device interface 62 determines whether a series of pointing data received from touch pad 60 corresponding to a pre-determined pattern has been input.

In one example, the touch pad 60 responds to positional information. Touch pad 60 registers an initial location where a user finger touches the pad, and subsequent finger movement is related to that initial point to identify the user action. Touch pad 60 also senses single taps or multiple taps of the finger at any point on the touch pad as corresponding to different user actions. Touch pad 60 utilizes electrical circuitry within the pad to convert a user's touch into an electrical signal. For example, touch pad 60 may be based on sensing of electrical properties such as capacitance.

As shown in FIG. 1, the touch pad may be mounted at the top surface of the headset boom. In a further example, the touch pad is mounted at the top surface of the headset body or other suitable location on the headset. In further examples, one or more buttons are provided adjacent the touch pad to be pressed. In one example use of the touch pad, sliding a finger towards the microphone performs the Next action and sliding the finger towards the ear performs the Previous action. Tapping once performs the Select action, tapping twice performs the Cancel action, and tapping three times returns the user to a Home location.

The use of a strip shaped touch pad is advantageous in that it provides a flat and compact structure suitable to the small form factor and shape of the headset boom or ear loop. Furthermore, the use of a touch pad is particularly convenient since the user may easily operate the touch pad without the need for the user to visually locate the buttons on the headset surface or identify the function of the buttons. This allows the user to easily and reliably perform a plurality of desired actions.

In a menu navigation example, generally, at a given state the user is presented with a menu of items from which to select. The Next and Previous functions allow a user to quickly advance through the choices available in the menu. In order to hear the next item on the menu, the user touchably slides his or her finger in a first direction along the touch pad to perform a “Next” action. In order to hear the previous item on the menu, the user touchably slides his finger in a second direction along the touch pad in a direction opposite the first direction to perform a “Previous” action. Once the desired item is output to the user, the user performs a “Select” action by invoking a selection protocol. For example, the “Selection” action may be performed by tapping the touch pad once.

Depending on the particular state, once the item is selected a subsequent sub-menu of items may be presented to the user from which the user may select. In this manner, the user can navigate a series of menus and submenus. At any time, the user may perform a “Cancel” action by invoking a cancel protocol. For example, the “Cancel” action may be performed by tapping the touch pad twice. Depending on the particular state, the “Cancel” action may return the user to the next higher level. The “Home” action may return the user to the top level menu. For convenience, the user may enter several actions in rapid succession without hearing the menu options presented, as referred to as barge-in in voice response units. For example, the user may initiate several “Next” actions in rapid succession followed by a “Select” action.

For a headset with additional functionality, example top-level menu choices (also referred to herein as “modes”) include ‘Phone’, ‘Email’, and ‘Calendar’. Additional top-level menu choice could include, for example, ‘Google’, ‘Weather’, ‘Scores’, ‘Stock quotes’ or other similar items. In default mode the system automatically and sequentially scrolls through the choices, but the Next and Previous functions allow the user to rapidly get to the desired choice. The Select function is used when the menu navigation comes to the action the user wants to take.

The Cancel function addresses the frustrations associated with many interactive systems, particularly voice based, where the user ends up in an area of the menu structure that he doesn't want to be in. For instance, with voice dialing the system may respond with the incorrect person the user wishes to dial. Most menu driven systems that don't have visual feedback are deficient on the cancel function. The Cancel function would stop the action under way and return the user to the next higher level in the menu, in this example ‘voice dial’. Repeated Cancels would ultimately bring the user to the idle state. Alternatively, the Home action may bring the user to the idle state.

In one example, the user interface is also capable of performing a Home action. It returns the user to the top level of the menu, typically the Standby state. It can be considered a ‘never mind’ function. No matter where the user is in the menu, it returns him to the top level. This feature is advantageous if the user is interrupted in the middle of retrieving information (e.g. asked a direct question at a meeting). The same function can be achieved through repeated use of the Cancel function until the user ends up at the top of the hierarchy.

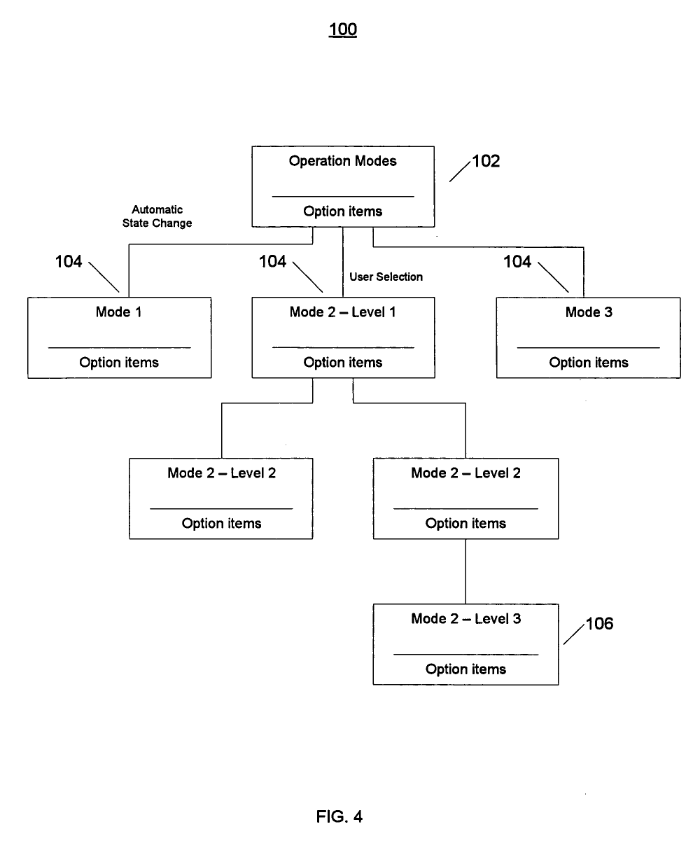

FIG. 4 illustrates an example hierarchically ordered menu 100 in which a user may navigate with a headset in an example of the invention. It should be noted that for simplicity, only a single selection path is shown corresponding to an operation mode two. For example, at a top level 102, a list of top level operational modes may be presented. For example, such modes may include outgoing call, email access, etc. Menu 100 is navigated by the user listening to menu items in order to select a particular item at that level. Once an item is selected, the next lower level menus 104 associated with the user selection are presented to the user. This procedure is continued until either a bottom level menu 106 is reached and an item on the lower level menu is selected or the user performs a Cancel or Home action using the user interface. It should be noted that the procedure described is bidirectional and the user may go in either direction along a desired path. The particular arrangement of the groupings and content of the menus is of course dependent on what is appropriate for the selected operation mode.

In addition to state changes caused when a user selects a menu item, the headset 22 may undergo a state change independent of user actions. Upon a state change, the actions performed by operation of user interface 38 automatically change. For example, the headset may automatically change from an idle state to an incoming call state upon receipt of an incoming call. As a further example, when a user initiates a call, the headset may change states when the call is established and voice communications with a far end speaker are occurring. Controller 44 detects the occurrence of a state change and responds accordingly such that user actions at user interface 38 correspond correctly to the control the headset.

The Next, Previous, Select, and Cancel actions perform different functions depending on the present state, operational mode, or menu that the user is at when the action is initiated. For example, such states may include the following: Idle, Incoming call, Outgoing Call, Email Access, and Calendar Access. Fewer or greater states may exist in additional examples. Each of the states is incorporated into the headset 22 having a user interface 38 which has Next, Previous, Select, Home, and Cancel selectors.

The following use cases present example operation of the headset in various states. The use cases are intended merely as an example, and are a non-exhaustive list of possible interactions. For simplicity, only user actions and consequences are described. In the following examples, if a user interface action is not listed it means the action is ignored.

Idle State

The user is not using the headset to perform a function:

NEXT—volume up

PREVIOUS—volume down

Incoming Call

The user receives indication of an incoming call through ring tones:

NEXT—answer the call

PREVIOUS—answer the call

SELECT—answer the call

CANCEL—reject the call

Outgoing Call

The user wishes to make an outgoing call:

SELECT—initiates the top-level menu

The system then responds with the possible choices—‘Phone’, ‘Email’ or ‘Calendar’. These are presented to the user in sequence through voice synthesis. If no choice is made, the choices are presented a second time. If no choice is still made, the system returns to the idle state:

NEXT—quickly advances to the next choice

PREVIOUS—quickly returns to the previous choice

SELECT—selects the choice, in this case ‘Phone’

CANCEL—returns to the top-level menu

HOME—returns to idle state

The user is then prompted with voice synthesis on how to complete the call—‘Name dial’ or ‘Digit dial’:

NEXT—quickly advances to the next choice

PREVIOUS—quickly returns to the previous choice

SELECT—selects the choice, in this case ‘Digit dial’

CANCEL—returns to the ‘Name Dial, or ‘Digit Dial’ menu

HOME—returns to idle state

The user is then prompted to speak the desired number to be dialed. This is interpreted by a voice recognition system, optionally confirmed with voice synthesis and the call is completed, unless:

CANCEL—the user is then prompted to speak the number again

HOME—returns to idle state

Email Access

The user wishes to retrieve through voice synthesis any unread emails:

SELECT—initiates the top-level menu

The system then responds with the possible choices—‘Phone’, ‘Email’ or ‘Calendar’:

NEXT—quickly advances to the next choice

PREVIOUS—quickly returns to the previous choice

SELECT—selects the choice, in this case ‘Email’

CANCEL—returns to idle state

HOME—returns to idle state

If there are no unread emails the system responds with ‘You have no unread emails’. The system returns to the idle state automatically.

If there are unread emails the system responds with ‘You have x unread emails. First email’ followed by a description of the first email—sender and subject. If the user does nothing, after a slight hesitation the body of this email will be read through voice synthesis and the system will automatically continue to the next email. Once the entire list of emails has been read the system automatically returns to the idle state. If the user does respond to the description, the following happens:

NEXT—advances to the next email

PREVIOUS—the sender and subject are repeated

SELECT—the body of the email is read. Upon completion the system goes to the next email

CANCEL—advances to the next email. If this is the last email, returns to the idle state

HOME—returns to idle state

While the body of the email is being read, the user can do the following:

NEXT—advances to the next email. If this is the last email, returns to the idle state

PREVIOUS—backs up x seconds (configured by user preference) in the reading of the email. This can be done repeatedly

CANCEL—advances to the next email. If this is the last email, returns to the idle state

HOME—returns to the idle state

Calendar Access

The user wishes to retrieve through voice synthesis any unread emails:

SELECT—initiates the top-level menu

The system then responds with the possible choices—‘Phone’, ‘Email’ or ‘Calendar’:

NEXT—quickly advances to the next choice

PREVIOUS—quickly returns to the previous choice

SELECT—selects the choice, in this case ‘Calendar’

CANCEL—returns to idle state

HOME—returns to idle state

Once ‘Calendar’ is selected, the system responds with ‘Your next meeting is at (time) at location (location). The subject is (subject).’ If the user does nothing, the system will automatically move on to the next meeting. Once the entire list of meetings for the day has been read the system automatically returns to the idle state. If the user performs an action while the meeting information is being read, the following happens:

NEXT—advances to the next meeting. If this is the last meeting, returns to the idle state

PREVIOUS—the meeting information is repeated. This can be done repeatedly

CANCEL—advances to the next meeting. If this is the last meeting, returns to the idle state

HOME—returns to idle state

The various examples described above are provided by way of illustration only and should not be construed to limit the invention. Based on the above discussion and illustrations, those skilled in the art will readily recognize that various modifications and changes may be made to the present invention without strictly following the exemplary embodiments and applications illustrated and described herein. Such changes may include, but are not necessarily limited to the location of the user interface on the headset and the elements of the menu structure for a given application. Furthermore, the shapes and sizes of the illustrated mobile communication device housing and components may be altered. Such modifications and changes do not depart from the true spirit and scope of the present invention that is set forth in the following claims.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

What is claimed is:

1. A communications headset comprising:
a housing;
a speaker;
a microphone;
an audio prompt unit for outputting an audio prompt through the speaker; and
a user interface comprising a strip-shaped touch pad disposed on the housing adapted to receive a user action associated with a next command, previous command, select command, cancel command, and home command.

2. (canceled)

3. The communications headset of claim 1, wherein the housing comprises a boom and the strip-shaped touch pad is disposed on the boom.

4. The communications headset of claim 1, wherein the audio prompt comprises an earcon.

5. The communications headset of claim 1, wherein the audio prompt comprises an audio voice prompt.

6. (canceled)

7. The communications headset of claim 1, wherein an action confirmation is output from the speaker following the user action.

8. The communications headset of claim 7, wherein the action confirmation comprises an earcon.

9. The communications headset of claim 8, wherein the earcon comprises a tone sweeping up or down in frequency.

10. The communications headset of claim 7, wherein the action confirmation comprises a new audio prompt.

11. The communications headset of claim 1, further comprising a wireless communications module.

12. The communications headset of claim 1, wherein the next command, previous command, select command, cancel command, and home command perform different functions responsive to a user selected operation mode.

13. A communications headset comprising:
a housing comprising a boom;
a speaker;
a microphone; and
a strip-shaped touch pad disposed on the boom capable of performing actions associated with a next command, previous command, select command, cancel command, and home command, wherein such actions may be performed by movement along the strip-shaped touch pad in a first direction towards the microphone, movement along the strip-shaped touchpad in a second direction towards the speaker, tapping the strip-shaped touch pad once, tapping the strip-shaped touch pad twice in rapid succession, or tapping the strip-shaped touch pad three times in rapid succession.

14. (canceled)

15. The communications headset of claim 13, wherein an action confirmation is output from the speaker following the user action.

16. The communications headset of claim 15, wherein the action confirmation comprises an earcon.

17. The communications headset of claim 15, wherein the action confirmation comprises a new audio prompt.

18. The communications headset of claim 13, further comprising a wireless communications module.

19. The communications headset of claim 13, wherein the next command, previous command, select command, cancel command, and home command perform different functions responsive to a user selected operation mode.

20. A communications headset comprising:
a housing means comprising a boom means for extending a microphone;
a speaker means for outputting an audio signal;
a microphone means for receiving a voice communication;
a voice prompt means for outputting an audio prompt through the speaker means; and
a user input means disposed on the boom means adapted to receive a user action associated with a next command, previous command, select command, cancel command, and home command.

21. The communications headset of claim 20, wherein an action confirmation is output from the speaker means following the user action.

22. The communications headset of claim 21, wherein the action confirmation comprises an earcon.

23. The communications headset of claim 21, wherein the action confirmation comprises a new audio prompt.

24. The communications headset of claim 20, further comprising a wireless communications means for wireless communication.

25. The communications headset of claim 20, wherein the next command, previous command, select command, and cancel command, and home command perform different functions responsive to a user selected operation mode.

26. A method for using a communications headset comprising:
providing a headset with a user interface disposable on a headset boom and adapted to receive a user action associated with a next command, previous command, select command, cancel command, and home command, wherein the headset includes a plurality of operational modes;
receiving a selected operational mode from a user;
outputting an audio prompt responsive through a headset speaker responsive to the selected operational mode;
receiving the user action associated with a next command, previous command, select command, cancel command or home command.

27. The method of claim 26, further comprising outputting an action confirmation responsive to the user action.

28. The method of claim 27, wherein the action confirmation comprises an earcon.

29. The method of claim 27 wherein the action confirmation comprises a new audio prompt.

30. The method of claim 26, wherein the user interface comprises a strip-shaped touch pad.
